(19) United States
(12) Patent Application Publication
(10) Pub. No.: US 2009/0153691 A1
(43) Pub. Date: Jun. 18, 2009

(54) IMAGING APPARATUS AND IMAGING METHOD

(75) Inventors: Yoshimasa AOYAMA, Tokyo (JP); Tomohide CHIDA, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/266,456

(22) Filed: Nov. 6, 2008

(30) Foreign Application Priority Data
Dec. 17, 2007 (JP) 2007-325158

(51) Int. Cl. H04N 5/228; H04N 5/222

(52) U.S. Cl. 348/222.1; 348/333.02; 348/E05.031; 348/E05.022

(57) ABSTRACT

According to one embodiment, an imaging apparatus includes an imaging unit, a first image data obtaining unit, a second image data obtaining unit, and a composite image data obtaining unit. The imaging unit obtains image data of a predetermined imaging area. The first image data obtaining unit obtains, as first image data, image data of part of the imaging area to be cut out as a first imaging area from the image data. The second image data obtaining unit obtains, as second image data, image data of part of the imaging area to be cut out as a second imaging area from the image data. The composite image data obtaining unit obtains composite image data representing a composite screen image of a screen image of the first imaging area and a screen image of the second imaging area based on the first image data and the second image data.

### CROSS-REFERENCE TO RELATED APPLICATIONS

This application is based upon and claims the benefit of priority from Japanese Patent Application No. 2007-325158, filed Dec. 17, 2007, the entire contents of which are incorporated herein by reference.

### BACKGROUND

1. Field

One embodiment of the invention relates to an imaging apparatus and an imaging method.

2. Description of the Related Art

As a technology in the imaging field, there has been known a camera control system disclosed in Japanese Patent Application Publication (KOKAI) No. 2000-106671. This system receives requests for part of an image captured by a camera from a plurality of users, and shoots an image of a minimum area including areas relating to the respective requests using the camera. The images of the respective areas relating to the requests are cut out from the image of the shot area, and then distributed to the respective users. This mechanism enables to distribute images of desired viewpoints and angles to a plurality of users, respectively, using one camera.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view of an external appearance of a camera apparatus as an imaging apparatus according to an embodiment of the invention;

FIG. 2 is an exemplary block diagram of the camera apparatus of FIG. 1 in the embodiment;

FIG. 3 is an exemplary view of areas captured by the camera apparatus of FIG. 1 in the embodiment;

FIG. 4 is an exemplary block diagram of a functional configuration of the camera apparatus of FIG. 1 in the embodiment;

FIG. 5 is an exemplary flowchart of a process of recording a imaging area A in a two-screen simultaneous recording process in the embodiment;

FIG. 6 is an exemplary flowchart of a process of recording a imaging area B in the two-screen simultaneous recording process in the embodiment;

FIG. 7 is an exemplary view for explaining movement of an object in the imaging area in the embodiment;

FIG. 8 is an exemplary view for explaining a shift of the imaging area in response to the movement of the object in the embodiment;

FIG. 9 is an exemplary view of a monitor screen in a first-type screen display in the embodiment;

FIG. 10 is an exemplary flowchart of a first-type screen display process in the embodiment;

FIG. 11 is an exemplary view of a monitor screen in a second-type screen display in the embodiment;

FIG. 12 is an exemplary flowchart of a second-type screen display process in the embodiment; and

FIG. 13 is an exemplary flowchart of a composite image data recording process in the embodiment.

### DETAILED DESCRIPTION

Various embodiments according to the invention will be described hereinafter with reference to the accompanying drawings. In general, according to one embodiment of the invention, an imaging apparatus includes: an imaging unit that obtains image data of a predetermined imaging area; a first image data obtaining unit that obtains, as first image data, image data of part of the imaging area to be cut out as a first imaging area from the image data; a second image data obtaining unit that obtains, as second image data, image data of part of the imaging area to be cut out as a second imaging area from the image data; and a composite image data obtaining unit that obtains composite image data representing a composite screen image of a screen image of the first imaging area and a screen image of the second imaging area based on the first image data and the second image data.

According to another embodiment of the invention, an imaging method includes: obtaining image data of a predetermined imaging area; obtaining, as first image data, image data of part of the imaging area to be cut out as a first imaging area from the image data; obtaining, as second image data, image data of part of the imaging area to be cut out as a second imaging area from the image data; and obtaining composite image data representing a composite screen image of a screen image of the first imaging area and a screen image of the second imaging area based on the first image data and the second image data.

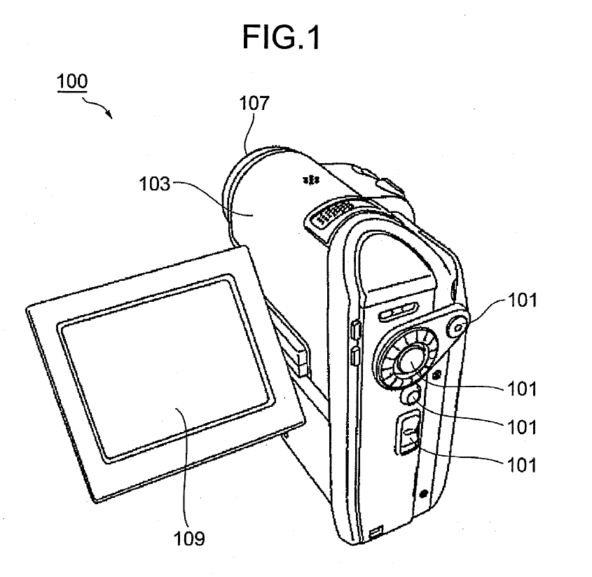

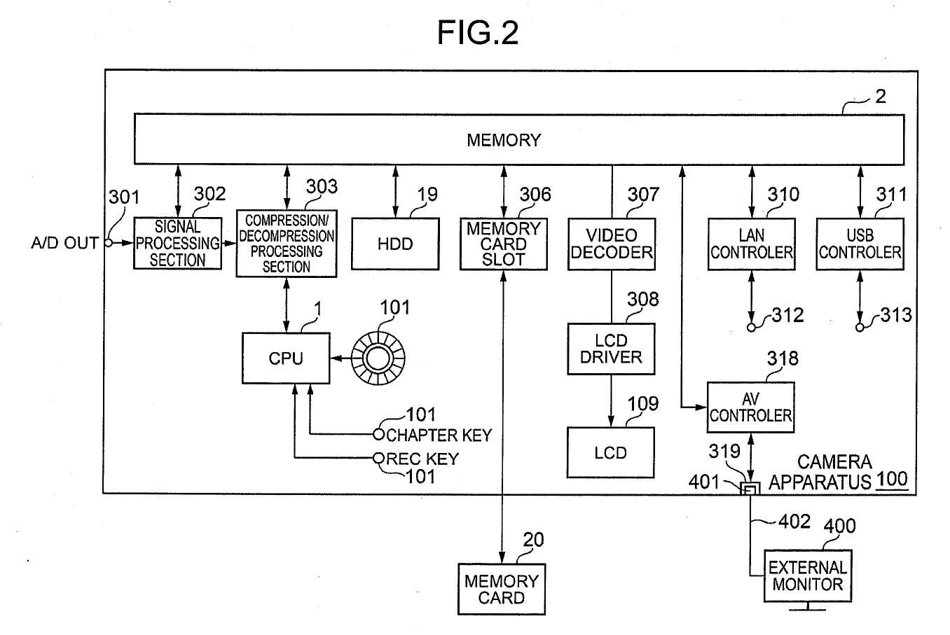

Described below is an imaging apparatus and an imaging method according to an embodiment of the present invention. A camera apparatus 100 illustrated in FIG. 1 and FIG. 2 will be specifically explained as the imaging apparatus of the embodiment. The camera apparatus 100 is a portable digital video camera apparatus for shooting mainly a moving image but capable of shooting a still image.

As illustrated in FIG. 1, the camera apparatus 100 includes a main body 103 having various operation keys 101, and a camera unit 107 provided at a front of the main body 103. The camera unit 107 includes an optical lens and an image sensor such as CCD (Charge Coupled Device) built in the back of the optical lens, and obtains image data by capturing an imaging area determined by an angle of view in a forward direction of the lens.

Further, the camera apparatus 100 has an LCD (monitor) 109 displaying on a screen the image data and the like obtained by the camera unit 107. The LCD 109 is attached to a side surface of the main body 103 in a movable manner.

The camera apparatus 100 handles data compressed using MPEG-2 when shooting or reproducing a moving image. When reproducing a moving image, the camera apparatus 100 easily provides trick play such as rewind, fast-forward, fast rewind, frame-by-frame forward and reverse in addition to normal playback. Further, unlike a case in which a magnetic tape is employed as an image data recording medium, a random-accessible recording medium such as an HDD 19 or a memory card 20 is employed in the camera apparatus 100. This allows a user to search a desired image easily.

The camera apparatus 100 includes a digital signal output section 301, a signal processing section 302, a compression/decompression processing section 303, a memory 2 and the HDD (Hard Disk Drive) 19, as illustrated in FIG. 2.

The camera apparatus 100 also includes a memory card slot 306, a video decoder 307, an LCD (Liquid Crystal Display) driver 308, the LCD 109, a LAN controller 310 and a USB controller 311. Further, the camera apparatus 100 includes a LAN terminal 312, a USB terminal 313, a CPU 1, the operation keys 101, an AV controller 318, and an AV terminal 319.

The CCD (Charge Coupled Device) of the camera unit 107 (FIG. 1) generates an analog electric signal by using an optical image of an object obtained through the lens. The digital signal output section 301 converts the analog electric signal generated by the CCD into a digital signal, and outputs it to the signal processing section 302.

The signal processing section 302 performs image processing on the input digital signal to thereby generate moving image data indicating an image actually shot. Namely, the signal processing section 302 has a function as a moving image data generating unit. The moving image data is once stored in the memory 2.

The compression/decompression processing section 303 compresses the moving image data read from the memory 2 using MPEG-2 to thereby produce compressed moving image data, or compresses still image data using JPEG to produce compressed still image data. Further, in accordance with an instruction from the CPU 1, the compression/decompression processing section 303 decompresses the compressed moving image data and the compressed still image data.

The memory 2 temporarily stores data to be processed by the signal processing section 302, and data to be processed by the compression/decompression processing section 303.

The HDD 19 is an external storage device for storing compressed moving image data, sound data and compressed still image data to an HD (Hard Disc) built therein. The HDD 19 reads data from and writes data to the HD on a random-access basis.

The memory card (external storage medium) 20 such as an SD (Secure Digital) memory card is inserted into the memory card slot 306, and the memory card slot 306 reads data from and writes data to the inserted memory card 20. Compressed moving image data and the like are recorded on the memory card 20.

In order to display an image shot by using compressed moving image data, the video decoder 307 decodes the moving image data and outputs the data to the LCD driver 308 and the AV controller 318. The video decoder 307 maybe a software decoder implemented by a decoding program.

The LCD driver 308 converts the decoded moving image data received from the video decoder 307 into a display signal compatible with an interface of the LCD 109. The LCD 109 displays the shot image by using the display signal output from the LCD driver 308. Further, the LCD 109 displays a GUI in accordance with an operation of the user.

In accordance with an instruction from the CPU 1, the LAN controller 310 transfers moving image data read from the memory 2 to an external device (not shown), such as a DVD recorder or an HDD recorder, connected via the LAN terminal 312. Besides, the LAN controller 310 outputs moving image data received from the external device via the LAN terminal 312 to the memory 2.

In accordance with an instruction from the CPU 1, the USB controller 311 transfers moving image data read from the memory 2 to an external device (not shown), such as a personal computer, connected via the USB terminal 313. Besides, the USB controller 311 outputs moving image data received from the external device via the USB terminal 313 to the memory 2.

In accordance with a program stored in a ROM (not shown), the CPU 1 operates as various units (a GUI switching unit, a parameter setting unit, a connection determining unit, an obtaining unit, and a display determining unit). Further, the CPU 1 exchanges a signal with the other components to control the overall operation of the camera apparatus 100 as well as the respective sequences.

The operation keys 101 include a JOG dial, a cross key, a chapter key, a REC key, and the like. The operation keys 101 are operation devices operated by a user to select or implement various functions (for example, start and stop of reproduction, termination and suspension of shooting, and the like) of the camera apparatus 100. When the JOG dial is operated during moving image reproduction, reproduction speed is adjusted according to the operation.

The user presses the chapter key to provide input of a chapter generating instruction to the CPU 1. The chapter generating instruction is data to instruct the CPU 1 to generate chapter data and record the generated chapter data on a chapter table. With the use of the chapter key, the chapter data can be generated by manual operation of the user. The user presses the REC key to provide input of an instruction to start recording to the CPU 1.

In accordance with an instruction from the CPU 1, the AV controller 318 outputs moving image data read from the memory 2 to an external monitor 400 connected via the AV terminal 319 and an AV cable 402, to thereby display a moving image on the external monitor 400. Besides, in accordance with an instruction from the CPU 1, the AV controller 318 displays the GUI on the LCD 109 based on a predetermined display parameter. Further, the AV controller 318 establishes communication with the external monitor 400 in accordance with an instruction from the CPU 1.

The AV terminal 319 is configured such that a connector 401 of the AV cable 402 is inserted thereinto. To the AV terminal 319, on the opposite side of the connector 401, a cable provided with any of a composite terminal, an S terminal, a component terminal, a D terminal and an HDMI terminal can be connected as the AV cable 402. The AV cable 402 is configured such that the external monitor 400 is connected to the side opposite the connector 401.

The camera apparatus 100 is configured to determine whether or not the external monitor 400 is a display device capable of high-resolution display (referred to as “high-resolution display device”) based on the shape of the terminal of the AV cable 402 connected to the AV terminal 319.

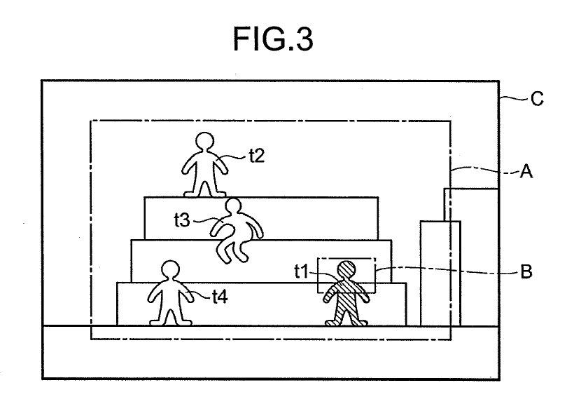

In the camera apparatus 100, assuming that image data obtained from the camera unit 107 (FIG. 1) is image data of an imaging area C illustrated in FIG. 3, the camera apparatus 100 has a function for simultaneously obtaining image data of a desired imaging area A included in the imaging area C (first image data; hereinafter, refer to as “image data a”) and image data of a desired imaging area B included in the imaging area A (second image data; hereinafter, refer to as “image data b”) In the example of FIG. 3, a wide-angle area including objects t1 to t4 is designated as the imaging area A, and part of the imaging area A in which one object t1 is in focus and zoomed in is designated as the imaging area B.

In addition, the camera apparatus 100 has a function for storing the image data a and the image data b individually in the HDD 19 or the external storage medium 20 at the same time. Further, the camera apparatus 100 has a function for recording a composite screen image composed of a screen image of the imaging area A and a screen image of the imaging area B based on the obtained image data a and image data b, and for displaying the composite screen image on the monitor (LCD) 109.

Specifically, with the camera apparatus 100, it is possible to cut out two screen images from one screen image shot by one camera, i.e., the camera unit 107, and to record each of the two screen images or a composite screen image composed of a combination of the two screen images.

Through such functions, the user can use the camera apparatus 100 in such a way that, when shooting a school play of his child, for example, he can shoot video footage of his child (object t1 in FIG. 3) zoomed in as the imaging area B while simultaneously shooting an image of the entire stage of the school play in a wide angel as the imaging area A.

Described below is a configuration of the camera apparatus 100 for achieving the respective functions as described above.

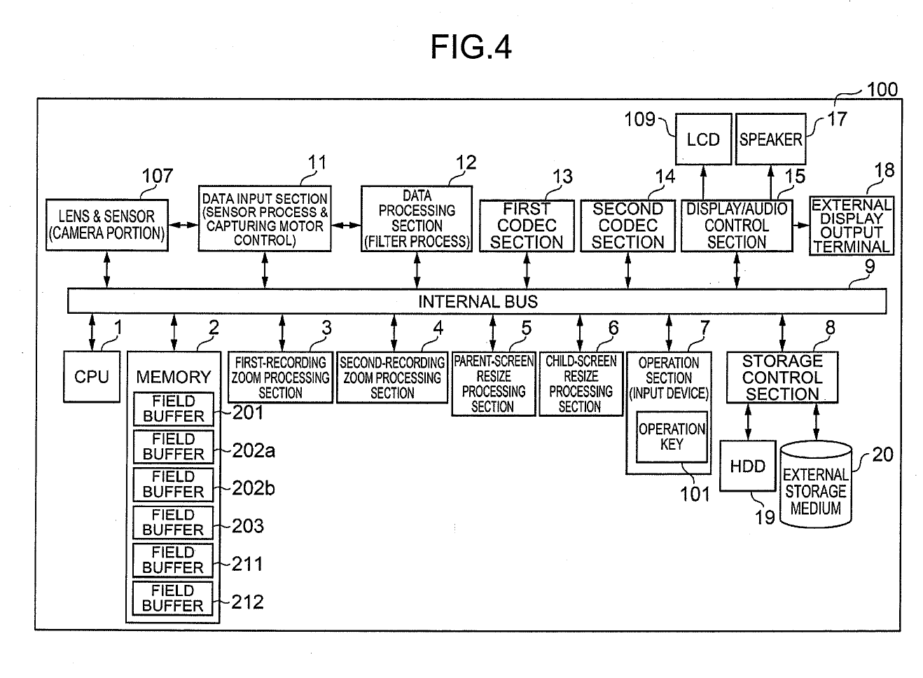

FIG. 4 is a block diagram of a functional configuration of the camera apparatus 100. As described above, the camera apparatus 100 includes the CPU 1 controlling the respective sections of the camera apparatus 100, the memory 2 for storing image data, an operation section 7 including the operation keys 101, and the HDD 19 storing image data.

In addition, the camera apparatus 100 has a storage control section 8 storing image data in the HDD 19, a data input section 11 performing respective processes on image data obtained by the camera unit 107, a data processing section 12, a first-recording zoom processing section 3, a second-recording zoom processing section 4, a parent-screen resize processing section 5, a child-screen resize processing section 6, a first codec section 13, and a second codec section 14.

Further, the camera apparatus 100 includes a display/audio control section 15 which performs screen display on the LCD 109, output of sound from a speaker 17, output of video data to an external display output terminal 18, and the like. The aforementioned respective sections exchange data with one another via an internal bus 9. The functional components of the camera apparatus 100 as described above may be realized as software in which the respective physical components as illustrated in FIG. 2 cooperate in accordance with a predetermined program, or as a physical circuit.

The data transmission/reception and data processing performed by the aforementioned respective sections when the camera apparatus 100 conducts a two-angle-of-view image simultaneous recording of the image data a and b will be explained with reference to FIG. 4 to FIG. 6.

(Two Angle-of-View Image Simultaneous Recording Process)

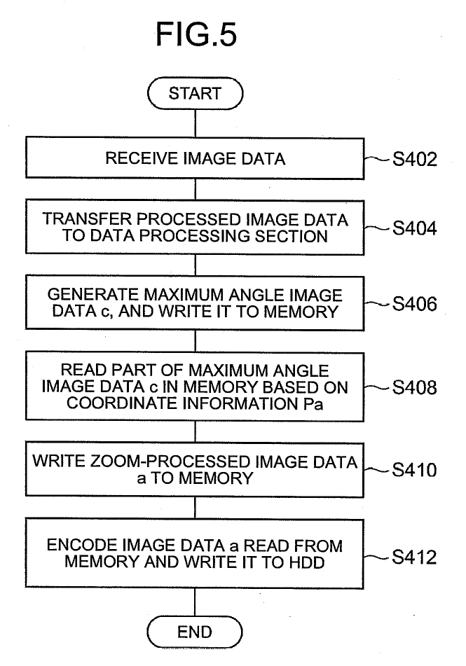

As illustrated in FIG. 4 and FIG. 5, image data obtained by the camera unit 107 is input to the data input section 11 (S402). The data input section 11 rearranges the order and the like of the data so that the data processing section 12 can perform image processing on a unit of the data, and then transfers the image data to the data processing section 12 (S404). The data processing section 12 performs, on the received image data, image processing such as various denoising processes and demosaicing process according to the pixel array of a sensor.

Further, the data processing section 12 generates maximum angle image data (hereinafter, refer to as “maximum angle image data c”) which can be generated from a sensor pixel in the camera unit 107, and writes it to a field buffer area 201 in the memory 2 (S406). Note that the maximum angle image data c corresponds to the imaging area C in FIG. 3.

Next, the first-recording zoom processing section 3 reads a part of the maximum angle image data c written to the field buffer area 201 as the aforementioned image data a (S408). Coordinate information Pa of four corners of the rectangular imaging area A is stored in the operation section 7, and in the read operation, data of corresponding portion necessary and sufficient to obtain the image data a is read based on the coordinate information Pa.

Subsequently, the first-recording zoom processing section 3 performs zoom process including pixel interpolation/decimation and the like corresponding to a designated image format with respect to the image data a, and writes the processed data to a field buffer area 202a in the memory 2 (S410).

Next, the first codec section 13 reads the image data a written to the field buffer area 202a, and writes the data to the HDD 19 via the storage control section 8 after encoding the data (S412). According to the processes as described above, the image data a of the imaging area A is stored in the HDD 19. Thus, the video image of the imaging area A is recorded.

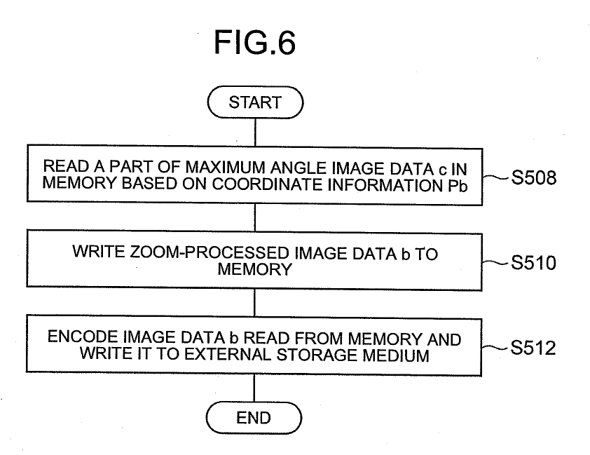

In parallel with the aforementioned processes S408 to 412, the second-recording zoom processing section 4 reads a part of the maximum angle image data c written to the field buffer area 201 as the aforementioned image data b (S508) as illustrated in FIG. 4 and FIG. 6. Coordinate information Pb of four corners of the rectangular imaging area B is stored in the operation section 7, and in the read operation, data of corresponding portion necessary and sufficient to obtain the image data b is read based on the coordinate information Pb.

Subsequently, the second-recording zoom processing section 4 performs zoom process including pixel interpolation/decimation and the like corresponding to a designated image format with respect to the image data b, and writes the processed data to a field buffer area 202b in the memory 2 (S510).

Next, the second codec section 14 reads the image data b written to the field buffer area 202b, and writes the data to the external storage medium 20 via the storage control section 8 encoding the data (S512). According to the processes as described above, the image data b of the imaging area B is stored in the external storage medium 20. Thus, the video image of the imaging area B is recorded.

According to the processes as described above, the image data a and b of two angles of view can be simultaneously obtained from the same image data obtained by one camera, i.e., the camera unit 107. Thus, the two angle-of-view image simultaneous recording function can be realized.

If the aforementioned processes S508 to S510 are not performed, only the image data a relating to the imaging area A can be recorded. In like manner, if the aforementioned processes S408 to S410 are not performed, only the image data b relating to the imaging area B can be recorded.

Even in the middle of the two angle-of-view image simultaneous recording process, by stopping the aforementioned processes S508 to S510 at an appropriate timing of field process in accordance with a predetermined operation input through the operation keys 101, it is possible to stop the recording of only the image data b. Similarly, by stopping the aforementioned processes S408 to S410 at an appropriate timing of field process in the middle of the two angle-of-view image simultaneous recording process, it is possible to stop the recording of only the image data a.

Further, if the same image format is designated for the first-recording zoom processing section 3 in the process S410 and the second-recording zoom processing section 4 in the process S510, the image data a and b can be recorded in the same image format. On the other hand, if different image formats are designated, the image data a and b can be recorded in mutually different image formats.

Further, if the data are encoded at the same compression rate by the first codec section 13 in the process S412 and the second codec section 14 in the process S512, the image data a and b can be recorded at the same compression rate. On the other hand, if both the compression rates are set to be different from each other, the image data a and b can be recorded at mutually different compression rates.

Such selection of setting regarding the recording operation may be conducted in accordance with the operation of the operation keys 101.

(Cut-Out Position Changing Process for Imaging Area B)

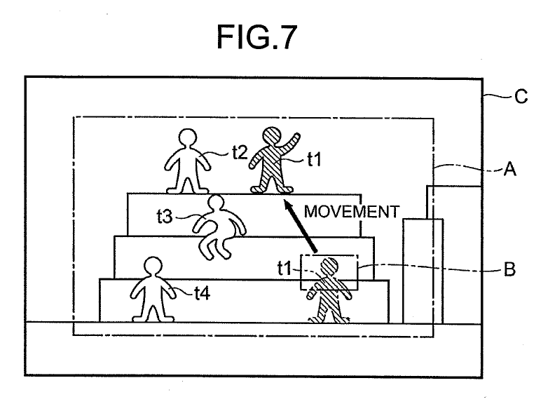

The camera apparatus 100 has a function for shifting, in the middle of the aforementioned two angle-of-view image simultaneous recording process, the imaging area B within the imaging area A in accordance with a key operation input through the operation keys 101 (FIG. 1). For example, a case is assumed where the object t1 moves from the imaging area B within the imaging area A in the middle of the two angle-of-view image simultaneous recording process, as illustrated in FIG. 7. In this case, in order to make the imaging area B follow the movement of the object t1, the user operates the operation keys 101 such as a cross key, thereby giving movement vector information regarding the cut-out position of the imaging area B to the operation section 7.

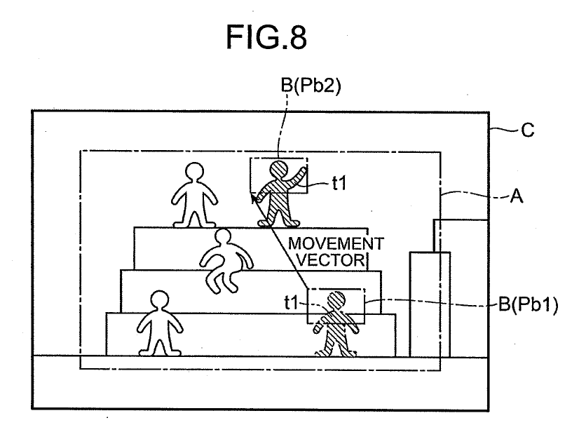

As illustrated in FIG. 8, when a predetermined operation is input through the operation keys 101, the movement vector information indicating a movement vector of the imaging area B is given to the operation section 7. As described above, the operation section 7 stores the coordinate information Pb on four corners of the imaging area B. The operation section 7 calculates coordinate positions Pb2 of four corners of the imaging area B after the movement in accordance with the given movement vector information.

When the coordinate positions Pb2 as a result of calculation are within the imaging area A, the operation section 7 updates the stored coordinate information (denoted by Pb1) to new coordinate information Pb2. Meanwhile, when the coordinate positions Pb2 as a result of calculation are out of the imaging area A, coordinate positions Pb3 of four corners after the movement are recalculated using a movement vector obtained by subtracting the amount of movement vector being out of the imaging area A from the movement vector, and the stored coordinate information Pb1 is updated to new coordinate information Pb3.

According to such update of the coordinate information Pb, a read position of data partially read from the maximum angle image data in the field buffer area 201 is changed in the process S508 of the aforementioned two angle-of-view image simultaneous recording process (FIG. 6). As a result of the aforementioned processes, the position of the imaging area B from which the image data b is obtained can be shifted in response to the movement of the object t1.

Note that in the process S508, the second-recording zoom processing section 4 performs control not to change the position of the imaging area B while one field of image data is being read, thereby preventing disturbance of a video image obtained as the image data b.

With this function, the user can use the camera apparatus 100 in such a manner that, when his child (object t1) moves on the stage of a school play, for example, he can shift the imaging area B representing a zoomed-in shot of the child following the movement of the child. In this case, if a moving range of the object t1 is within the imaging area A, the follow movement can be realized in a stable state with a zoomed angle of view without changing a direction of lens of the camera apparatus 100. That is, operability is enhanced, which enables to achieve an effect of preventing hand-shake blur.

(Process of First-Type Screen Display)

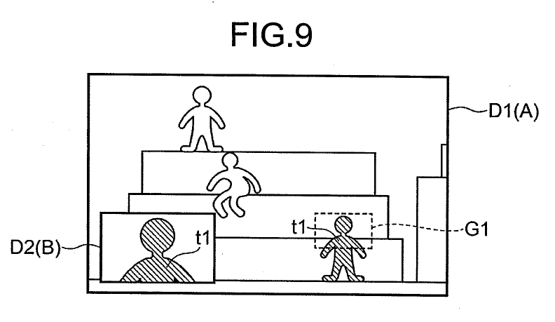

The camera apparatus 100 has a function for simultaneously displaying the aforementioned image data a and image data b on a screen of the monitor (LCD) 109 (FIG. 1). For example, as illustrated in FIG. 9, the image data a of wide angle is displayed on the entire area of the monitor 109 as a parent screen D1, and the zoomed-in image data b is displayed overlaid on part of the parent screen D1 as a child screen D2 having a smaller size than the parent screen D1.

Hereinafter, screen display in which the image data a is displayed on the parent screen D1 and the image data b is displayed on the child screen D2 as described above is referred to as “first-type screen display”. The relationship between the “parent screen” and the “child screen” is defined as follows: the child screen is smaller than the parent screen and overlaid on the parent screen.

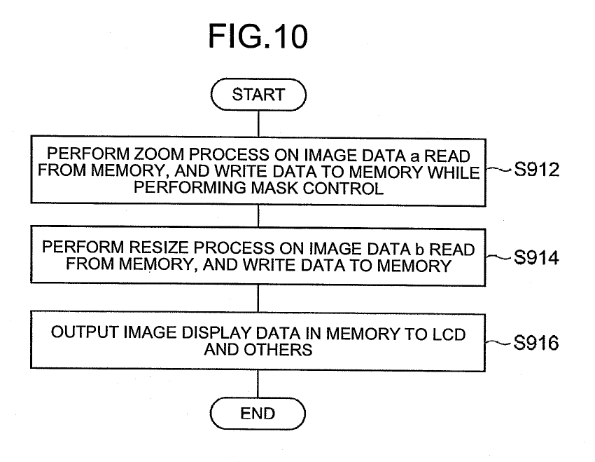

A concrete process to realize a function of this first-type screen display will be explained with reference to FIG. 4 and FIG. 10.

In S410 of the aforementioned two-screen simultaneous recording process, the zoom-processed image data a has been written to the field buffer area 202a. The parent-screen resize processing section 5 reads the image data a. Subsequently, the parent-screen resize processing section 5 performs zoom process including pixel interpolation/decimation and the like corresponding to a designated image format with respect to the image data a, and writes the processed image data a to a field buffer area 203 in the memory 2 (S912).

In the data writing process, the parent-screen resize processing section 5 refers to display coordinate information R on the child screen D2 stored in the operation section 7, and masks the field buffer area of a portion corresponding to an area indicated by the display coordinate information R not to destroy it by the writing to write the image data b thereto. Note that the aforementioned display coordinate information R is information on a display position of the child screen D2 on the monitor 109, and indicates coordinates of four corners of the rectangular child screen D2.

Further, in S510 of the aforementioned two-screen simultaneous recording process, the zoom-processed image data b has been written to the field buffer area 202b. In parallel with the process of the parent-screen resize processing section 5, the child-screen resize processing section 6 reads the image data b. Subsequently, the child-screen resize processing section 6 performs resize process including pixel interpolation/decimation and the like according to an image format corresponding to the aforementioned display coordinate information R with respect to the image data b.

Subsequently, the child-screen resize processing section 6 writes the processed image data b to the field buffer area 203 (S914). At this time, the image data b is written to the portion corresponding to the area indicated by the display coordinate information R in the field buffer area 203.

According to the aforementioned processes of the parent-screen resize processing section 5 and the child-screen resize processing section 6, screen display data is completed in the field buffer area 203. The screen display data represents a composite screen image composed of a screen image of the imaging area A indicated by the image data a and a screen image of the imaging area B indicated by the image data b. The screen display data is sent to the display/audio control section 15, and is output at a timing corresponding to interfaces of the LCD 109 and the external display output terminal 18 (S916).

Accordingly, on the LCD 109, the parent screen D1 displaying the image data a is displayed with the child screen D2 displaying the image data b overlaid thereon as illustrated in FIG. 9. According to the aforementioned processes, the function of the first-type screen display is realized. With the use of the screen display function, the user of the camera apparatus 100 can check images of two angles of view which are being recorded.

(Process of Second-Type Screen Display)

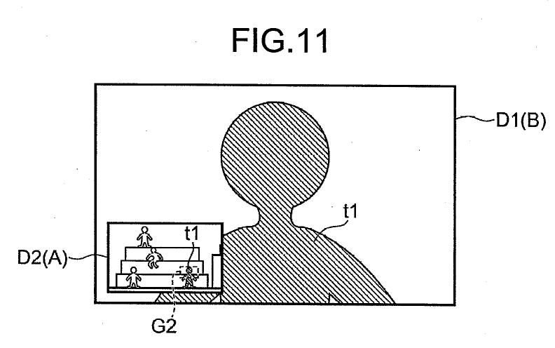

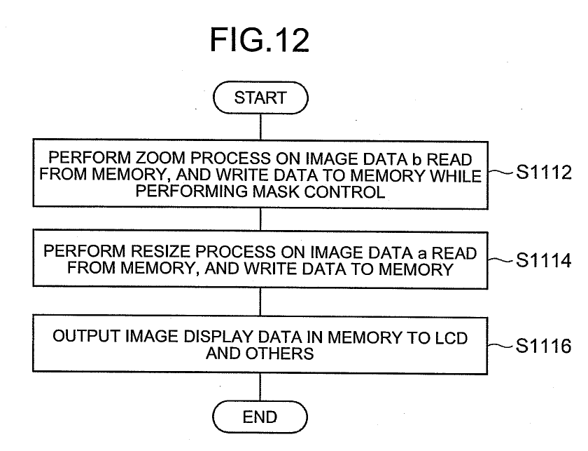

The camera apparatus 100 can also display the image data b on the parent screen D1 and display the image data a on the child screen D2, as illustrated in FIG. 11. Hereinafter, such a screen display is referred to as “second-type screen display”. A concrete process to realize a function of this screen display will be explained with reference to FIG. 4 and FIG. 12. In the following, the same explanation as previously described for the “first-type screen display” will not be repeated.

First, the parent-screen resize processing section 5 reads the image data b written to the field buffer area 202b, and performs the same process as the process S912 for the aforementioned “first-type screen display” (S1112). Specifically, the parent-screen resize processing section 5 performs zoom process on the image data b in the field buffer area 202b, and writes the data to the field buffer area 203 in the memory 2 while performing mask control.

Meanwhile, the child-screen resize processing section 6 reads the image data a written to the field buffer area 202a, and performs the same process as the process S914 for the aforementioned “first-type screen display” (S1114). Specifically, the child-screen resize processing section 6 performs zoom process on the image data a in the field buffer area 202a, and writes the data to the field buffer area 203 in the memory 2.

Subsequently, similarly as S916, the screen display data completed in the field buffer area 203 is sent to the display/audio control section 15, and is output at a timing corresponding to the interfaces of the LCD 109 and the external display output terminal 18 (S1116). Accordingly, on the LCD 109, the parent screen D1 displaying the image data b is displayed with the child screen D2 displaying the image data a overlaid thereon as illustrated in FIG. 11. According to the above-described processes, the function of the second-type screen display is realized.

Such first- and second-type screen display processes can be conducted with respect to both image data which is being recorded and image data which is not recorded. For instance, if the “first- or second-type screen display process” is performed without performing S412 in the “two angle-of-view image simultaneous recording process”, the image data a can be displayed on the screen even if it is not recorded.

In like manner, if the “first- or second-type screen display process” is performed without performing S512 in the “two angle-of-view image simultaneous recording process”, the image data b can be displayed on the screen even if it is not recorded. Such a selection regarding the screen display may be conducted in accordance with the operation of the operation keys 101.

(Switch Control Process Between Parent Screen and Child Screen)

The camera apparatus 100 has a screen switching function for switching, in accordance with the operation of the operation keys 101, image data being displayed on the parent screen D1 with image data being displayed on the child screen D2. Described below is a concrete process to realize this function.

When a predetermined operation is input through the operation keys 101, screen display type information indicating which of the image data a and b is displayed on the parent screen is given to the operation section 7, and the screen display type information is stored in the operation section 7. The CPU 1 instructs, based on the screen display type information, the parent-screen resize processing section 5 and the child-screen resize processing section 6 as to which screen display process between the aforementioned “first- and second-type screen display processes” is to be conducted.

In accordance with the instruction, the parent-screen resize processing section 5 and the child-screen resize processing section 6 switch the types of screen display process from the first one (S912 and S914) to the second one and S1114), or from the second one to the first one. According to the processes as described above, the screen switching function is realized.

(Display Position Changing Process of Child Screen)

In the camera apparatus 100, a display position of the child screen D2 on the monitor 109 can be changed in accordance with the operation of the operation keys 101. Described below is a concrete process to realize this function.

When a predetermined operation is input through the operation keys 101, movement vector information on the child screen D2 is given to the operation section 7. As described above, the operation section 7 stores the display coordinate information R on the child screen D2. The operation section 7 calculates display coordinate positions R2 after the movement in accordance with the given movement vector information, and updates, when the display coordinate positions R2 are within the parent screen D1, the stored display coordinate information (denoted by R1) to display coordinate information R2 as a result of calculation.

Meanwhile, when the display coordinate positions R2 are out of the parent screen D1, display coordinate positions R3 after the movement are recalculated using a movement vector obtained by subtracting the amount of movement vector being out of the parent screen D1 from the movement vector, and the stored display coordinate information R1 is updated to the display coordinate positions R3.

Accordingly, the display coordinate information R used in the aforementioned first- and second-type screen display processes (S912 and S914, S1112 and S1114) is updated. As a result, the display position of the child screen D2 on the monitor 109 is changed. Note that in the first- and second-type screen display processes, the parent-screen resize processing section 5 and the child-screen resize processing section 6 perform control not to change the display position of the child screen D2 while one field of image data is being read, thereby preventing disturbance of a video image.

(Display Size Changing Process for Child Screen)

In the camera apparatus 100, a display size of the child screen D2 on the monitor 109 can be changed in accordance with the operation of the operation keys 101. Described below is a concrete process to realize the function.

When a predetermined operation is input through the operation keys 101, magnification information indicating magnification (enlargement/reduction) ratio of the size of the child screen D2 is given to the operation section 7. As described above, the operation section 7 previously stores the display coordinate information R on the child screen D2. The operation section 7 calculates display coordinate positions R2 after the size change in accordance with the given magnification information, and updates, when the display coordinate positions R2 are within the parent screen D1, the stored display coordinate information (denoted by R1) to display coordinate information R2 as a result of calculation.

Meanwhile, when the display coordinate positions R2 are out of the parent screen D1, display coordinate positions R3 after the size change are recalculated using a movement vector obtained by subtracting the amount of movement vector being out of the parent screen D1 from the movement vector, and the stored display coordinate information R1 is updated to the display coordinate positions R3.

Accordingly, the display coordinate information R used in the aforementioned first- and second-type screen display processes (S912 and S914, S1112 and S1114) is updated. As a result, the display size of the child screen D2 on the monitor 109 is changed. Note that in the first- and second-type screen display processes, the parent-screen resize processing section 5 and the child-screen resize processing section 6 perform control not to change the display size of the child screen D2 while one field of image data is being read, thereby preventing disturbance of a video image.

(Process to Hide Child Screen)

In the camera apparatus 100, it is possible to hide the child screen D2 in accordance with the operation of the operation keys 101. Described below is a concrete process to realize this function.

When a predetermined operation is input through the operation keys 101, display/non-display information as to whether to display or not the child screen D2 is given to the operation section 7. In the operation section 7, already stored display/non-display information is updated with the given display/non-display information.

Here, when the display/non-display information is updated from “display” to “non-display”, the CPU 1 makes the mask control on the field buffer area 203 by the parent-screen resize processing section 5 (S912, S1112) off, and also stops the process by the child-screen resize processing section 6 (S914, S1114) in the aforementioned “first- and second-type screen display processes”. According to the processes as described above, the child screen D2 is hidden.

(First-Type Guide Display)

As illustrated in FIG. 9, in the camera apparatus 100, it is possible to display a guide G1 of a rectangular frame indicating a cut-out position of the imaging area B on the parent screen D1 displaying the image data a in the aforementioned first-type screen display. Further, display/non-display of the guide G1 can be selected by the operation of the operation keys 101. Hereinafter, such a display of the guide G1 is refereed to as “first-type guide display”. Described below is a concrete process to realize the function.

When a predetermined operation is input through the operation keys 101, guide display/non-display information as to whether to display or not the guide G1 is given to the operation section 7. In the operation section 7, already stored guide display/non-display information is updated with the given guide display/non-display information.

If the guide display/non-display information indicates “display”, when the parent-screen resize processing section 5 writes the image data a to the field buffer area 203 in the process of the aforementioned “first-type screen display” (S912), an area to display the guide G1 is determined based on the coordinate information Pb on the imaging area B, and data of this area is replaced with image data for the guide G1. If the guide display/non-display information indicates “non-display”, the replacement with the image data is not conducted.

According to such processes, it is possible to display the guide G1, and to select whether or not to display the guide G1. With the use of such guide display function, the user of the camera apparatus 100 can easily check the cut-out position of the imaging area B on the monitor 109.

(Second-Type Guide Display)

As illustrated in FIG. 11, in the camera apparatus 100, it is possible to display a guide G2 of a rectangular frame indicating a cut-out position of the imaging area B on the child screen D2 displaying the image data a in the aforementioned second-type screen display. Further, display/non-display of the guide G2 can be selected by the operation of the operation keys 101. Hereinafter, such a display of the guide G2 is refereed to as “second-type guide display”. Described below is a concrete process to realize the function.

When a predetermined operation is input through the operation keys 101, guide display/non-display information as to whether to display or not the guide G2 is given to the operation section 7. In the operation section 7, already stored guide display/non-display information is updated with the given guide display/non-display information.

If the guide display/non-display information indicates “display”, when the child-screen resize processing section 6 writes the image data a to the field buffer area 203 in the process of the aforementioned “second-type screen display” (S1114), an area to display the guide G2 is determined based on the coordinate information Pb on the imaging area B, and data of this area is replaced with image data for the guide G2.

If the guide display/non-display information indicates “non-display”, the replacement with the image data is not conducted. According to such processes, the guide G2 can be displayed, and whether or not to display the guide G2 can be selected.

(First-Type composite Image Data Recording)

In the camera apparatus 100, it is possible to record, in a state of the “first-type screen display” as illustrated in FIG. 9, composite image data on a composite screen image composed of screen images of the imaging areas A and B. Hereinafter, such recording is referred to as “first-type composite image data recording”. Described below is a concrete process to realize the function.

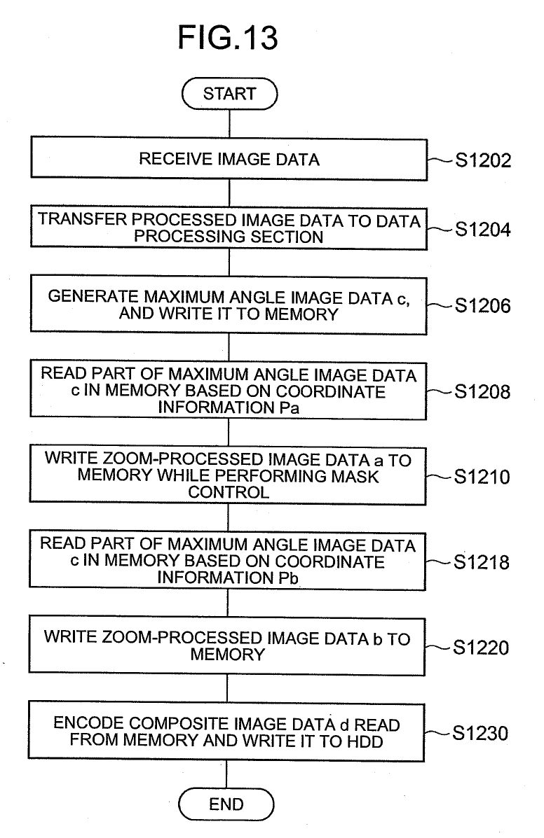

As illustrated in FIG. 4 and FIG. 13, image data obtained by the camera unit 107 is input to the data input section 11 (S1202). The data input section 11 rearranges the order and the like of the data so that the data processing section 12 can perform image processing on a unit of the data, and then transfers the image data to the data processing section 12 (S1204).

The data processing section 12 performs, on the received image data, image processing such as various denoising processes and demosaicing process corresponding to the pixel array of the sensor. Further, the data processing section 12 generates the maximum angle image data c, and writes it to a field buffer area 211 in the memory 2 (S1206).

Next, the first-recording zoom processing section 3 reads a part of the maximum angle image data c written to the field buffer area 211 as the image data a (S1208). In the read operation, data of corresponding portion necessary and sufficient to obtain the image data a is read based on the coordinate information Pa stored in the operation section 7.

Subsequently, the first-recording zoom processing section 3 performs zoom process including pixel interpolation/decimation and the like corresponding to a designated image format with respect to the image data a, and writes the processed data to a field buffer area 212 in the memory 2 (S1210). In this data writing process, the first-recording zoom processing section 3 masks a portion in the field buffer area 212 indicated by the display coordinate information R on the child screen D2 not to destroy it by the writing to write the image data b for the child screen D2 thereto.

In parallel with the aforementioned processes S1208 to S1210, the second-recording zoom processing section 4 reads a part of the maximum angle image data c written to the field buffer area 211 as the image data b (S1218). In the read operation, data of corresponding portion necessary and sufficient to resize or zoom in/out the imaging area B is read based on the coordinate information Pb.

Subsequently, the second-recording zoom processing section 4 performs resize process or zoom process including pixel interpolation/decimation and the like corresponding to an image format based on the display coordinate information R on the child screen D2 with respect to the image data b. Thereafter, the second-recording zoom processing section 4 writes the processed image data b to a portion in the field buffer area 212 indicated by the display coordinate information R (S1220).

According to the aforementioned processes S1210 and S1220, composite image data d composed of the image data a and the image data b is completed in the field buffer area 212 as field-unit data. This composite image data d represents a composite screen image composed of a screen image of the imaging area A based on the image data a and a screen image of the imaging area B based on the image data b. The first codec section 13 reads the composite image data d from the field buffer area 212.

Subsequently, the first codec section 13 encodes the composite image data d, and then writes the data to the HDD 19 via the storage control section 8 (S1230). According to the processes as described above, the composite image data d representing the composite screen image formed of the image data a as the parent screen D1 and the image data b as the child screen D2 is stored in the HDD 19. Thus, the first-type composite image data recording is achieved.

(Second-Type composite Image Data Recording)

In the camera apparatus 100, it is also possible to record, in a state of the “second-type screen display” as illustrated in FIG. 11, composite image data on a composite screen image composed of screen images of the imaging areas A and B. Hereinafter, such recording is referred to as “second-type composite image data recording”.

To realize this function, in the process of the aforementioned “first-type composite image data recording”, the first-recording zoom processing section reads apart of the maximum angle image data as the image data b based on the coordinate information Pb, and the second-recording zoom processing section reads a part of the maximum angle image data as the image data a based on the coordinate information Pa.

Otherwise, the same processes as previously described for the “first-type composite image data recording” are performed, and therefore, a detailed explanation thereof will be omitted. According to the processes as described above, the composite image data d representing the composite screen image formed of the image data b as the parent screen D1 and the image data a as the child screen D2 is stored in the HDD 19. Thus, the second-type composite image data recording is achieved.

(Process of Switching Types of Composite Image Data Recording)

In the camera apparatus 100, it is possible to change, in the process of the “first- or second-type composite image data recording” the type of composite image data recording from the first one to the second one, or from the second one to the first one. Described below is a concrete process to realize the function.

A case is assumed where the operation keys 101 are operated in the process of the “first- or second-type composite image data recording”. In accordance with the operation of the operation keys 101, the CPU 1 instructs the first-recording zoom processing section 3 and the second-recording zoom processing section 4 as to which one of the aforementioned “first- and second-type composite image data recording” processes is to be conducted.

In accordance with the instruction, the first-recording zoom processing section 3 and the second-recording zoom processing section 4 switch the type of composite image data recording from the first one to the second one, or from the second one to the first one at an appropriate timing. According to the processes as described above, the aforementioned function is realized. Note that the appropriate timing is a timing at which the reading of the maximum angle image data c in the field buffer area 211 is not switched in the middle of the field data.

(Process of changing Position of Child Screen in Composite Image data Recording)

In the camera apparatus 100, a position of the child screen D2 in the composite image data d can be changed in the process of the “first- or second-type composite image data-recording” in accordance with the operation of the operation keys 101. Described below is a concrete process to realize the function.

When a predetermined operation is input through the operation keys 101, movement vector information on the child screen D2 is given to the operation section 7. As described above, the operation section 7 stores the display coordinate information R on the child screen D2. The operation section 7 calculates display coordinate positions R2 after the movement in accordance with the given movement vector information, and updates, when the display coordinate positions R2 are within the parent screen D1, the stored display coordinate information (denoted by R1) to display coordinate information R2 as a result of calculation.

Meanwhile, when the display coordinate positions R2 are out of the parent screen D1, display coordinate positions R3 after the movement are recalculated using a movement vector obtained by subtracting the amount of movement vector being out of the parent screen D1 from the movement vector, and the stored display coordinate information R1 is updated to the display coordinate positions R3. Accordingly, the display coordinate information R used in the aforementioned first- and second-type composite image data recording processes is updated. As a result, the position of the child screen D2 in the composite image data d is changed.

(Process of Changing Size of Child Screen in Composite Image Data Recording)

In the camera apparatus 100, a size of the child screen D2 in the composite image data d can be changed in the process of the “first- or second-type composite image data recording” in accordance with the operation of the operation keys 101. Described below is a concrete process to realize the function.

When a predetermined operation is input through the operation keys 101, magnification information indicating magnification (enlargement/reduction) ratio of the size of the child screen D2 is given to the operation section 7. As described above, the operation section 7 previously stores the display coordinate information R on the child screen D2. The operation section 7 calculates display coordinate positions R2 after the size change in accordance with the given magnification information, and updates, when the display coordinate positions R2 are within the parent screen D1, the stored display coordinate information (denoted by R1) to display coordinate information R2 as a result of calculation.

Meanwhile, when the display coordinate positions R2 are out of the parent screen D1, display coordinate positions R3 after the size change are recalculated using a movement vector obtained by subtracting the amount of movement vector being out of the parent screen D1 from the movement vector, and the stored display coordinate information R1 is updated to the display coordinate positions R3. Accordingly, the display coordinate information R used in the aforementioned first- and second-type composite image data recording processes is updated. As a result, the size of the child screen D2 in the composite image data d is changed.

(Process of Stopping Recording on Child Screen in Composite Image Data Recording)

In the camera apparatus 100, it is possible to stop, in the process of the “first- or second-type composite image data recording”, recording on only the child screen D2 in the composite image data d in accordance with the operation of the operation keys 101. After that, recording is continued only on the parent screen D1. Described below is a concrete process to realize the function.

When a predetermined operation is input through the operation keys 101, child screen recording/non-recording information indicating whether or not to perform recording on the child screen D2 is given to the operation section 7. Subsequently, the operation section 7 updates already stored child screen recording/non-recording information to the given information. Now, a case is assumed where the child screen recording/non-recording information is updated from “recording” to “no-recording”.

In this case, in the middle of the first- or second-type composite image data recording process, the write mask control conducted by the first-recording zoom processing section 3 (S1210) is set to off, and the processes of the second-recording zoom processing section 4 (S1218 and S1220) are stopped.

(Process of Stopping Recording on Parent Screen in Composite Image Data Recording)

In the camera apparatus 100, it is possible to stop, in the process of the “first- or second-type composite image data recording”, recording on only the parent screen D1 in the composite image data d in accordance with the operation of the operation keys 101. After that, only the image data a or b recorded as the child screen D2 is continued to be recorded as the parent screen D1. Described below is a concrete process to realize the function.

When a predetermined operation is input through the operation keys 101, parent screen recording/non-recording information indicating whether or not to perform recording on the parent screen D1 is given to the operation section 7. Subsequently, the operation section 7 updates already stored parent screen recording/non-recording information to the given information. Now, a case is assumed where the parent screen recording/non-recording information is updated from “recording” to “no-recording”.

In this case, in the first- or second-type composite image data recording process, the processes conducted by the first-recording zoom processing section 3 and the first codec section 13 are switched to the processes S408 to S412 in the two-screen simultaneous recording process (FIG. 5) at an appropriate timing. According to the processes as described above, it is possible to stop the recording on only the parent screen D1 in the composite image data d, and to continue, thereafter, to record only image data recorded as the child screen D2 as the parent screen D1.

As described above, with the camera apparatus 100 and the imaging method thereof according to the embodiment, to the user can shoot, in a school play of his child, for example, his child being zoomed in while simultaneously shooting the entire stage of the school play, which provides greater thrill and pleasure through reproduced video images.

Further, even when an object of a zoom shot (user's child, for example) moves, if a moving range of the object is within an angle of view (within the imaging area A) of wide-angle shooting, the follow movement can be realized in a stable state with a zoomed angle of view without changing a direction of lens of the camera apparatus 100 through the aforementioned cut-out position changing process for the imaging area B. That is, operability is enhanced, which enables to achieve an effect of preventing hand-shake blur.

Further, with the camera apparatus 100 and the imaging method thereof, two different angles of view can be combined and recorded as the parent screen D1 and the child screen D2, which enhances the variation of recorded data. With conventional technologies, in order to obtain such a recorded video image, it has been necessary to cut out two screen images with different angles of view from one wide-angle recoded data and to edit them. On the other hand, with the camera apparatus 100 and the imaging method thereof, it is possible to provide to a viewer display of a composition which reflects the photographic intention of an image capturer without requiring editing capability and time.

Further, as described above, a setting of the composition of a composite screen image to be recorded can be specified by the image capturer in the middle of recording by using various functions of, for example, changing the position/size of the child screen, switching the type of composite image data recording, and stopping recording on only the parent screen or the child screen.

Note that the present invention is not limited to the above-described embodiment. For instance, in the aforementioned embodiment, the imaging area B is included within the imaging area A, but the imaging areas A and B may be independently cut out within the imaging area C.

Further, in the aforementioned embodiment, image data stored in the HDD 19 may be stored in the external storage medium 20, and image data stored in the external storage medium may be stored in the HDD 19.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An imaging apparatus comprising:
an imaging module configured to obtain image data of a predetermined imaging area;
a first partial image data obtaining module configured to obtain a first partial image data corresponding to a first imaging area from the image data;
a second partial image data obtaining module configured to obtain a second partial image data corresponding to a second imaging area from the image data; and
a composite image data obtaining module configured to obtain composite image data representing a composite screen image comprising a first screen image of the first imaging area and a second screen image of the second imaging area based on the first partial image data and the second partial image data.

2. The imaging apparatus of claim 1, wherein the second imaging area is comprised within the first imaging area.

3. The imaging apparatus of claim 2, further comprising a cut-out position changing module configured to change a cut-out position of the second imaging area within the first imaging area.

4. The imaging apparatus of claim 1, wherein
in the composite screen image represented by the composite image data, either the first screen image or the second screen image is displayed on a parent screen and either the second screen image or the first screen image is displayed on a child screen respectively, and
the child screen is smaller than the parent screen and is overlaid on the parent screen.

5. The imaging apparatus of claim 1, further comprising a screen display configured to display the composite image data on a screen.

6. The imaging apparatus of claim 1, further comprising a recording module configured to store the composite image data.

7. An imaging method comprising:
obtaining image data of a predetermined imaging area;
obtaining a first partial image data corresponding to a first imaging area from the image data;
obtaining a second partial image data corresponding to a second imaging area from the image data; and
obtaining composite image data representing a composite screen image of a first screen image of the first imaging area and a second screen image of the second imaging area based on the first partial image data and the second partial image data.
